(19) United States
(12) Patent Application Publication
(10) Pub. No.: US 2005/0064856 A1
(43) Pub. Date: Mar. 24, 2005

(54) Method and apparatus for managing functions in a camera phone

(75) Inventors: Steven Edward Atkin, Austin, TX (US); Edward Scott Rozmiarek, Round Rock, TX (US); Alvaro Sanchez-Cifuentes, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/666,792

(22) Filed: Sep. 18, 2003

(51) Int. Cl. H04M 3/00

(52) U.S. Cl. 455/418

(57) ABSTRACT

A method, apparatus, and computer instructions for managing a camera in a mobile communications unit. A location of the mobile communications unit in a selected area is determined. Depending on the location of the mobile communications unit, a signal is sent which causes at least one camera function in the mobile communications unit to be disabled or limited.

### BACKGROUND OF THE INVENTION

1. Technical Field

The present invention relates generally to an improved data processing system and in particular, to a method and apparatus for controlling functions in a camera phone. Still more particularly, the present invention relates to a method, apparatus, and computer instructions for managing camera functions in a camera phone.

2. Description of Related Art

Mobile phones have become commonplace in society. These phones allow for a user to have greater mobility, while staying in communication with others. With the emergence of mobile phones with built-in digital cameras or add-on camera modules, such a phone can send a picture taken using the camera over a wireless network to many recipients. These types of devices are referred to as “camera phones”. This combination of phone and camera features has provided large appeal to consumers. For example, most people carry mobile phones, but leave their digital cameras at home. With the combined functionality in a single unit, users are unlikely to miss various photographic moments.

Additionally, with camera phones, images may be associated with entries in a phone book. As a result, when someone calls a user, a picture of the caller may be seen in addition to just the name. Although a camera phone is primarily a phone and will not replace the digital camera, these features have made this new hybrid device very popular. One example of a camera phone is the Nokia 3650, available from Nokia Corporation.

The growing popularity of camera phones has created a new hidden security risk. With the widespread acceptance of mobile phones, people are accustomed to seeing them in use. However, many secure areas are present that allow mobile phones, but not cameras. For example, concerts and dressing rooms are places typically in which cameras are not allowed, but mobile phones are allowed. People using these camera phones have a greater ability to take unauthorized pictures in these secure or private areas because people do not always recognize when camera functions on a camera phone are being used. In many cases, camera phones have been banned in secure areas even though mobile phones are allowed. As a result, users with mobile phones without camera features are able to bring in and use those devices, while those with the camera features are not able to bring in their devices. Having to leave behind camera phones is an inconvenience for camera phone owners, leaving them without a communications device.

Therefore, it would be advantageous to have an improved method and apparatus to control the use of camera phones in secure areas.

### SUMMARY OF THE INVENTION

The present invention provides a method, apparatus, and computer instructions for managing a camera in a mobile communications unit. A location of the mobile communications unit in a selected area is determined. Depending on the location of the mobile communications unit, a signal is sent which causes at least one camera function in the mobile communications unit to be limited or disabled.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed data processing system in which the present invention may be implemented;

FIG. 2 is a block diagram of a camera phone in accordance with a preferred embodiment of the present invention;

FIG. 3 is a block diagram of a data processing system that may be implemented as a server in accordance with a preferred embodiment of the present invention;

FIG. 4 is a block diagram illustrating components used in managing the operation camera functions in a camera phone in accordance with a preferred embodiment of the present invention;

FIG. 5 is a flowchart of a process for managing camera functions in a camera phone in accordance with a preferred embodiment of the present invention;

FIG. 6 is a flowchart of a process for sending picture information to a mobile communications unit in accordance with a preferred embodiment of the present invention;

FIG. 7 is a flowchart of a process for sending pictures to a mobile communications unit in accordance with a preferred embodiment of the present invention;

FIG. 8 is a flowchart of a process for disabling camera functions in accordance with a preferred embodiment of the present invention;

FIG. 9 is a flowchart of a process for handling camera functions in a camera phone in accordance with a preferred embodiment of the present invention;

FIG. 10 is a flowchart of a process for receiving picture information in accordance with a preferred embodiment of the present invention; and

FIG. 11 is a flowchart of a process for receiving pictures in a secure area in accordance with a preferred embodiment of the present invention.

### DETAILED DESCRIPTION OF THE PREFERRED EMBODIMENT

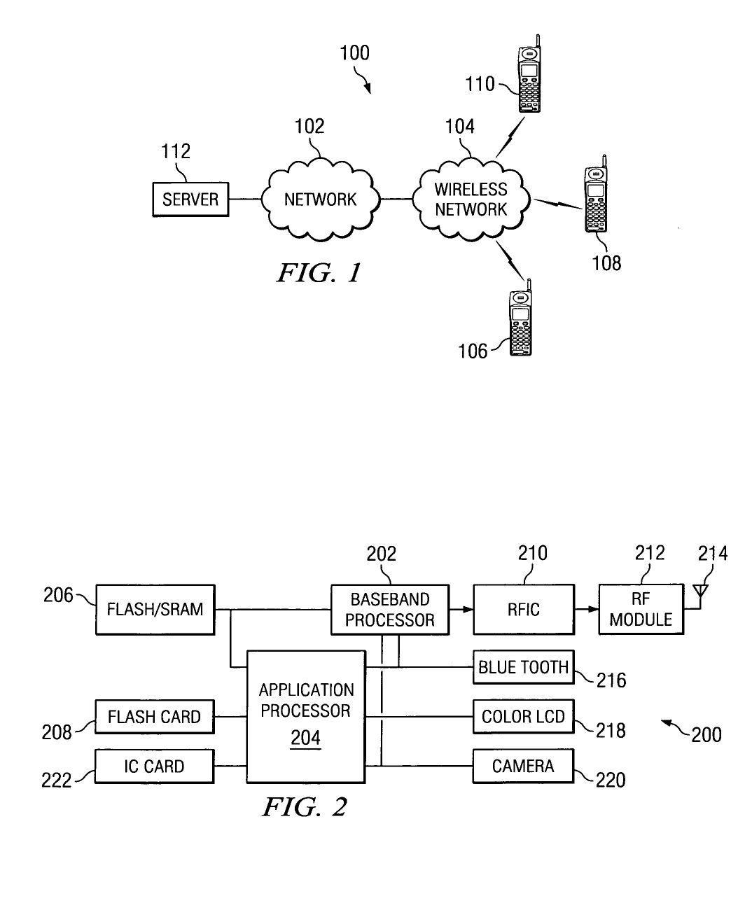

With reference now to the figures and in particular with reference to FIG. 1, a diagram of a distributed data processing system is shown in which the present invention may be implemented. In this example, distributed network data processing system 100 includes network 102 and wireless network 104. These networks provide the medium used to provide communications links between various devices and computers connected together within network data processing system 100. Network 102 may be implemented using various types of networks, such as, for example, a local area network (LAN), a wide area network (WAN), an Intranet, the Internet, or some combination of these types of networks. In these examples, the different networks and gateways within network 102 use transmission control protocol/Internet protocol (TCP/IP) suite of protocols to communicate with one another.

Wireless network 104 is a wireless network typically used for voice communications between mobile communications units, such as cell phones. The access protocol used in wireless network 104 may take various forms, such as, for example, time division multiple access (TDMA) and code division multiple access (CDMA). These are protocols typically used for forced communications to allow for communication between mobile communications units, such as mobile communications units 106, 108, and 110. In this example, server 112 is connected to network 102 and is an example of a component in which an illustrative embodiment of the present invention may be implemented. In particular, server 112 may send or initiate the sending of commands to mobile communications units 106, 108, and 110 to limit or disable various functions in these mobile communications units. In particular, in these examples, these functions are camera functions. These mobile communications units are camera phones including an integrated or attached camera.

Turning next to FIG. 2, a block diagram of a camera phone is depicted in accordance with a preferred embodiment of the present invention. Camera phone 200 includes baseband processor 202, application processor 204, flash/static random access memory (SRAM) 206, flash card 208, radio frequency integrated circuit (RFIC) 210, radio frequency (RF) module 212, antenna 214, Blue Tooth unit 216, color liquid crystal display (LCD) 218, camera 220, and IC card 222.

Baseband processor 202 provides for receiver and transmitter operations and is also referred to as a transceiver. In particular, baseband processor 202 handles all of the audio, signal, and data processing needed to receive and send data using RF transmissions or Blue Tooth transmissions. Application processor 204 provides the processing power for other functions within camera phone 200. For example, calculators, calendars, alarms, camera functions, and directories are provided through application processor 204. Flash/SRAM 206 is a storage device in which various instructions for providing the functions within camera phone 200 are located and provide upgrades. Flash card 208 is a storage device in which user data and applications may be stored. An example of flash card 208 is a secure digital card.

A pathway for the transmission of voice and other types of data is through RFIC 210. Additionally, short range transmissions may be sent or received through Blue Tooth unit 216. Blue Tooth unit 216 conforms to Blue Tooth wireless specification, which defines the link layer and application layer for product developers. Both of these transmissions are made through antenna 214 in this illustrative example.

Color LCD 218 provides a display for pictures and other data for camera phone 200. Camera 220, in this example, is a complementary metal oxide semiconductor (CMOS) camera which may be built into camera phone 200 or connected to camera phone 200 as a module, such as IC card 222. IC card 222 also may contain other application specific functions, such as a global positioning system (GPS) or other functions, such as a modem or additional memory.

Camera 220 forms the camera module of camera phone 200, while the other components form the digital phone module of camera phone 200 in these illustrative examples. Instructions or circuits are added to camera phone 200 to allow for control of the digital camera and allow limitations to camera functions according to a preferred embodiment of the present invention.

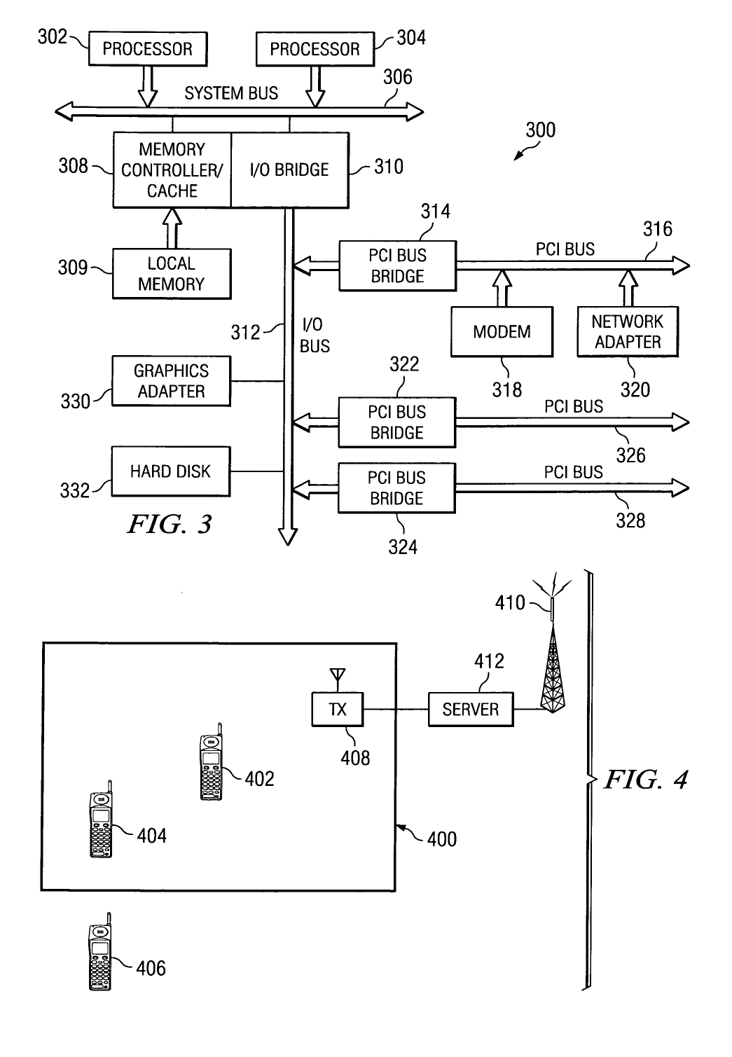

Referring to FIG. 3, a block diagram of a data processing system that may be implemented as a server is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to mobile communications units 106-110 in FIG. 1 may be provided through modem 318 and network adapter 320 connected to PCI local bus 316 through add-in boards.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer pSeries system, a product of International Business Machines Corporation in Armonk, New York, running the Advanced Interactive Executive (AIX) operating system or LINUX operating system.

Turning now to FIG. 4, a block diagram illustrating components used in managing the operation of camera functions in a camera phone are depicted in accordance with a preferred embodiment of the present invention. In this example, area 400 is a secure area in which photography is prohibited or restricted. Area 400 may be, for example, a theater, a room, a stadium, or some other area. Although the shape of area 400 is rectangular in these examples, the shape may vary depending on the particular implementation.

Mobile communications units 402 and 404 are located within area 400, while mobile communications unit 406 is outside of area 400. In these examples, wireless transmission device 408 may be used to transmit signals to limit the camera functions of mobile communications units 402 and 404, while allowing the telephone functions to remain in use.

Alternatively, a wireless transmission protocol, such as I.E.E.E. 802.11b, I.E.E.E. 802.11g, or Blue Tooth, may be employed. Such a feature allows for coverage within buildings and allows for varied controls based on different floors within a building or areas in which a mobile phone may not be able to connect to a phone network. In these examples, 802.11b is a specification stating an over-the-air interface between a wireless client and a base station or between two wireless clients. This specification and 802.11g has been developed by the Institute of Electrical and Electronics Engineers (IEEE). 802.11b is also referred to as WI-FI. In this example, wireless transmission device 408 is a Blue Tooth device. This device allows for coverage within buildings and allows for varied controls based on different floors within a building or in areas where a mobile phone may not be able to connect to a phone network.

Additionally, transmission tower 410 may be used to send signals to mobile communications units 402 and 404 when they are identified as being within area 400. Transmissions through transmission tower 410 are standard cellular transmissions. These transmissions may follow various protocols, such as, for example, code division multiple access (CDMA) or time division multiple access (TDMA). In these examples, the various signals transmitted by wireless transmission device 406 and transmission tower 410 are controlled by server 412.

The location of the different mobile communications units may be identified through GPS systems or triangulation processes based on the strengths of radio signals from mobile communications units 402, 404, and 406. The triangulation process uses signals from multiple transmission towers, such as transmission tower 410. Alternatively, in the illustrative examples, determining the location of the mobile communications units is unnecessary if wireless transmission device 408 is used because the coverage of this transmission device affects any mobile device receiving the signals. As illustrated, mobile communications unit 402 and mobile communications unit 404 receive signals from wireless transmission device 408, while mobile communications unit 406 does not receive the transmission of these signals. Thus, the coverage is limited by the range of wireless transmission device 408.

The mechanism of the present invention allows for limiting the camera functions of a camera phone while the mobile communications unit is within a secure area, such as area 400. The location of mobile communications units may be based on any location method, such as GPS or triangulation. Alternatively, a wireless transmission system, such as Blue Tooth, may be employed to limit camera functions in a mobile communications unit, such as a camera phone.

Examples of functions that may be limited or controlled in the camera phone include the total operation of the camera functions, limiting digital picture resolution, limiting an ability to record audio, limiting an ability to record digital video, and limiting the use of a flash on the camera phone.

Additionally, the mechanism of the present invention may be used to provide picture information distribution based on location. For example, in a public entertainment site in which people may walk around and take pictures, picture information may be sent to camera phones at the entertainment site, concerning locations that are optimal for taking pictures. Further, picture information may be sent to control the operation of the camera phone for taking optimal pictures. These sites may include, for example, museums and theme parks.

Further, an entertainment site may be a commercial site, which sells digital pictures and downloads those pictures directly to a user's camera phone. For example, if a person with a camera phone walks up to a painting in a museum, the camera phone may be disabled to prevent the user from taking a picture of the painting. An offer may be presented on the display of the camera phone for a picture of the painting in which the picture is downloaded to the user's camera phone for a fee.

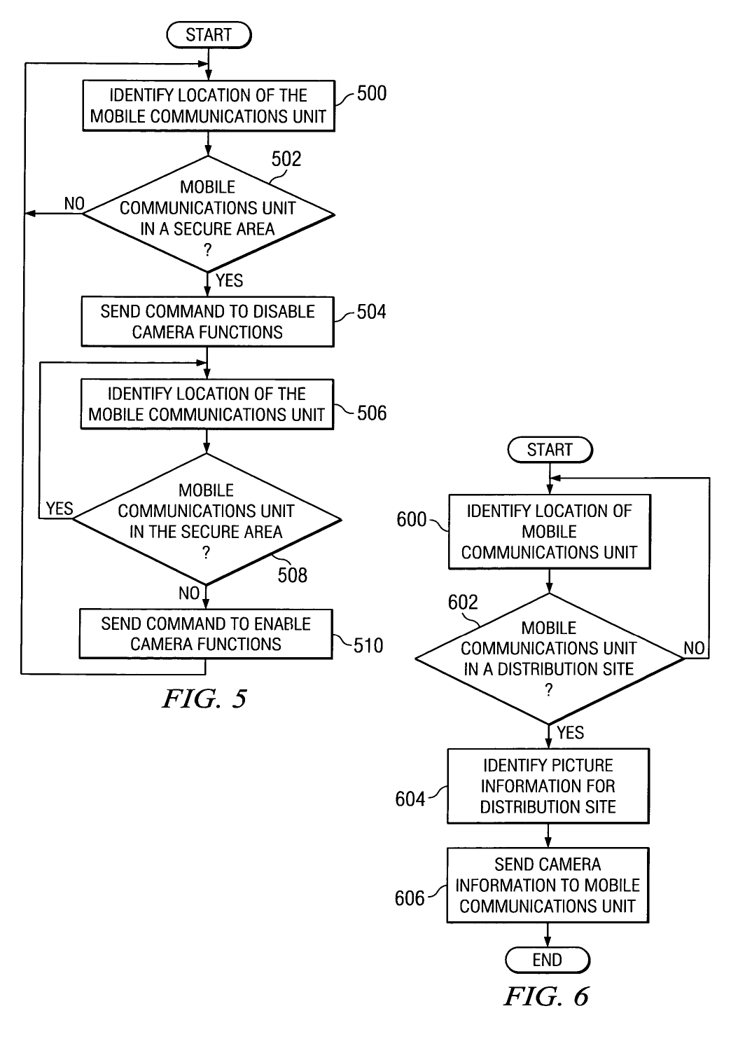

Turning now to FIG. 5, a flowchart of a process for managing camera functions in a camera phone is depicted in accordance with a preferred embodiment of the present invention. The process illustrated in FIG. 5 may be implemented in a server, such as server 410 in FIG. 4. The processes illustrated in this example are implemented using a transmission tower after locating a mobile communications unit.

The process begins by identifying the location of the mobile communications unit (step 500). The location of the mobile communications unit may be identified through various mechanisms, such as using a GPS system or triangulation of the signal from the mobile communications unit. Next, a determination is made as to whether the mobile communications unit is in a secure area (step 502). If the mobile communications unit is not in a secure area, the process returns to step 500.

Otherwise, a command is sent to disable camera functions in the mobile communications unit (step 504). The disablement of camera functions affect a particular function or all of the functions of the camera portion of the camera phone. For example, flash photography may be prohibited within the secure area. In this case, only the flash function of the camera phone is disabled. In other illustrative examples, the resolution of the camera phone may be limited or all of the functionality of the camera portion of the camera phone may be limited.

Next, the location of the mobile communications unit is identified (step 506). A determination is made as to whether the mobile communications unit is still present in the secure area (step 508). If the mobile communications unit remains in the secure area, the process returns to step 506. Otherwise, a command is sent to enable the camera function (step 510) with the process then returning to step 500 as described above.

Turning next to FIG. 6, a flowchart of a process for sending picture information to a mobile communications unit is depicted in accordance with a preferred embodiment of the present invention. The process illustrated in FIG. 6 may be implemented in a server, such as server 410 in FIG. 4.

The process begins by identifying the location of the mobile communications unit (step 600). A determination is then made as to whether the mobile communications unit is within a distribution site (step 602). In these examples, a distribution site is a location that has been defined as one in which picture information is to be sent to mobile communications units for the purpose of providing information for taking pictures. If the mobile communications unit is not within a distribution site, the process returns to step 600.

Otherwise, picture information for the distribution site is identified (step 604). This picture information may include an identification of locations for taking pictures. Further, this information may include maps for display on the mobile communications unit. Further, different camera settings for optimal picture taking also may be presented to the user. Additionally, depending on the particular implementation, camera settings may be sent directly to the camera phone to automatically set the camera phone for the user to take optimal pictures. Next, the camera information is sent to the mobile communications unit (step 606) with the process terminating thereafter.

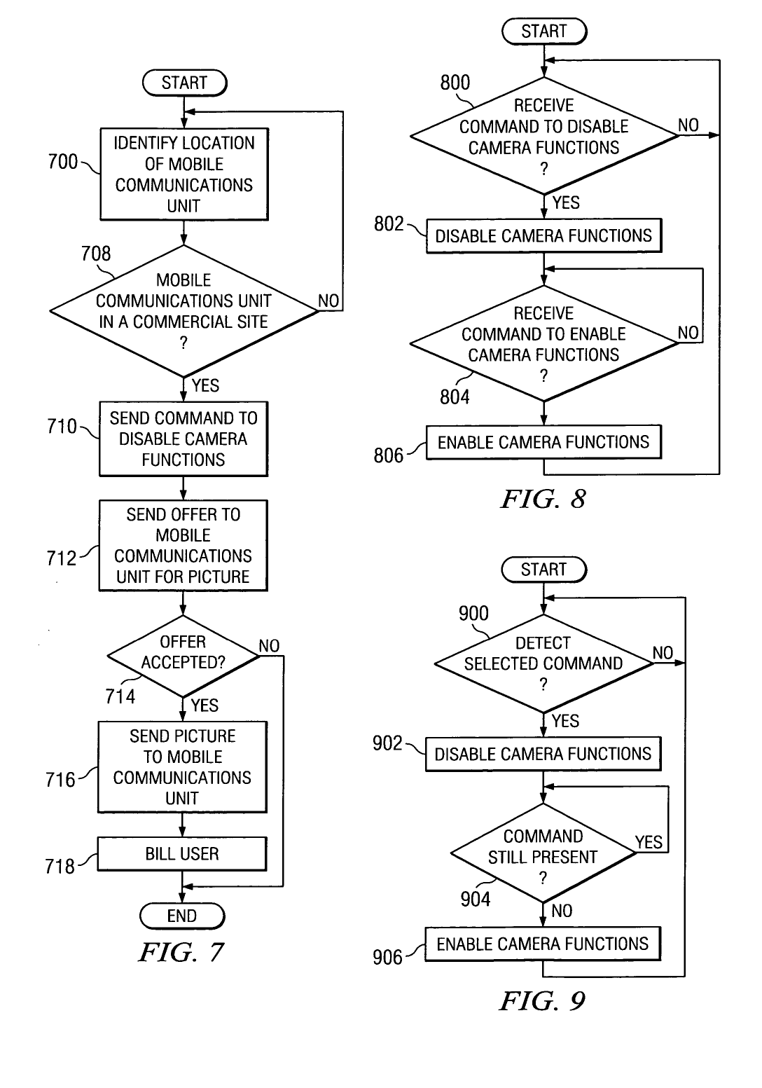

Turning next to FIG. 7, a flowchart of a process for sending pictures to a mobile communications unit is depicted in accordance with a preferred embodiment of the present invention. The process illustrated in FIG. 7 may be implemented in a server, such as server 410 in FIG. 4. The process illustrated in FIG. 7 is employed to send pictures to a camera unit in exchange for a fee when the camera phone is located within a selected location.

The process begins by identifying the location of the mobile communications unit (step 700). A determination is made as to whether the mobile communications unit is in a commercial site (step 708). In these examples, a commercial site is a site in which one or more camera functions may be disabled. Further, in this location, pictures are made available for purchase by users of mobile communications units, such as camera phones. If the mobile communications unit is not within a commercial site, the process returns to step 700.

Otherwise, a command is sent to the camera phone to disable camera functions (step 710). Then, an offer for a picture is sent to the mobile communications unit (step 712). A determination is made as to whether the offer has been accepted (step 714). If the offer has been accepted, the picture is sent to the mobile communications unit (step 716), and the user is billed (step 718). Thereafter, the process terminates.

With reference again to step 714, if the offer has not been accepted, the process terminates without transmitting a picture or billing the user.

With reference next to FIG. 8, a flowchart of a process for disabling camera functions is depicted in accordance with a preferred embodiment of the present invention. The process illustrated in FIG. 8 may be implemented in a mobile communications unit, such as camera phone 200 in FIG. 2.

The process begins by determining whether a command to disable camera functions has been received (step 800). The process continues to return to step 800 until such a command has been received. When such a command has been received, camera functions in the mobile communications unit are disabled as specified by the command (step 802). The camera functions disabled may be all of the functions or some subset of functions, depending on the particular implementation.

Thereafter, a determination is made as to whether a command has been received to enable the camera function (step 804). The process returns to step 804 until such a command is received. Upon receiving a command to enable camera functions, the functions are enabled (step 806) with the process then returning to step 800 as described above.

Turning now to FIG. 9, a flowchart of a process for handling camera functions in a camera phone is depicted in accordance with a preferred embodiment of the present invention. The process illustrated in FIG. 9 may be implemented in a mobile communications unit, such as camera phone 200 in FIG. 2. The process in this figure illustrates steps used in handling wireless transmission signals.

The process begins by determining whether a selected command has been detected (step 900). The process continues to return to step 900 until the selected command is detected over the wireless transmission. Upon receiving the command, camera functions are disabled (step 902). Then, a determination is made as to whether the command is still present in the signal (step 904). If the command is still present, the process continues to return to step 904. Otherwise, the camera functions are enabled (step 906) with the process then returning to step 900.

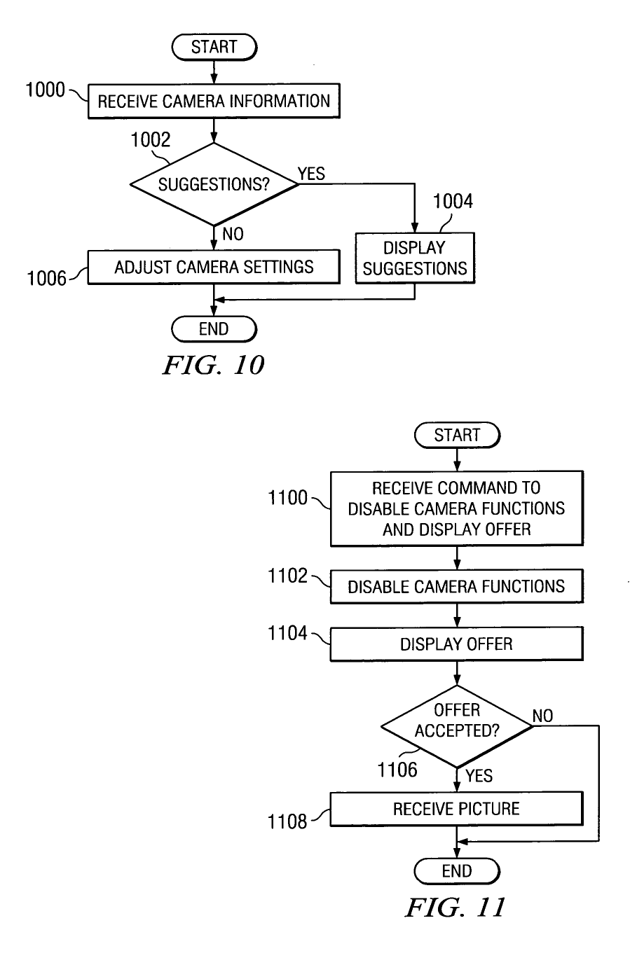

Turning now to FIG. 10, a flowchart of a process for receiving picture information is depicted in accordance with a preferred embodiment of the present invention. The process illustrated in FIG. 10 may be implemented in a mobile communications unit, such as camera phone 200 in FIG. 2.

The process begins by receiving camera information (step 1000). A determination is made as to whether the camera information contains suggestions with respect to taking pictures (step 1002). If the camera information contains suggestions, the suggestions are displayed on the mobile communications unit to the user (step 1004) with the process terminating thereafter. These suggestions may be, for example, light settings, whether to use a flash, resolution or focus suggestions, or a suggestion of a location from which to take pictures.

With reference again to step 1002, if the camera information does not take the form of suggestions, then camera settings are automatically adjusted (step 1006) with the process terminating thereafter. In this case, the camera information is a number of settings that are sent to the camera to automatically adjust or configure the camera for taking pictures at the particular location.

A software communications protocol and device functions protocol is employed to allow for control of the camera. Current protocols may be used with additional commands being added to those to allow for control of camera functions.

Turning next to FIG. 11, a flowchart of a process for receiving pictures in a secure area is depicted in accordance with a preferred embodiment of the present invention. The process illustrated in FIG. 11 may be implemented in a mobile communications unit, such as camera phone 200 in FIG. 2.

The process begins by receiving a command to disable camera phones and to display an offer (step 1100). Thereafter, camera functions are disabled (step 1102). The offer is displayed to the user (step 1104). A determination is then made as to whether the offer is accepted (step 1106). If the offer is not accepted, the process terminates. Acceptance of the offer results in the picture being received at the camera phone (step 1108) with the process terminating thereafter.

In this manner, the present invention provides an improved method, apparatus, and computer instructions for managing camera functions in a mobile communications unit such as a camera phone. The mechanism of the present invention allows for one or more camera functions in a camera phone to be selectively turned off or limited while allowing telephone or other communication functions to continue to operate. In this manner, areas in which photography may be limited may be controlled while allowing the user to continue to carry the camera phone. Further, this mechanism also may be used to provide picture information for taking of pictures to a user with the camera phone. Also, the mechanism of the present invention may be employed to sell digital pictures to camera phone users at certain locations, such as a museum or art exhibit.

The mechanism of the present invention identifies the overall position of the device using GPS or triangulation. This location method is especially useful in outdoor areas, such as outdoor concerts or arenas.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the mobile communications units in with disabled camera functions are camera phones in the depicted examples. The mechanism of the present invention also may be applied to other types of mobile communications units with camera functions. For example, a personal digital assistant with a camera may be controlled in a similar fashion if the PDA includes a wireless communications unit. In some cases, the PDA may not provide for voice communications, but may be controlled in a fashion similar to the camera phones described above. The embodiment was chosen and described in order to best explain the principles of the invention, the practical application, and to enable others of ordinary skill in the art to understand the invention for various embodiments with various modifications as are suited to the particular use contemplated.

1. A method in a data processing system for managing a camera in a mobile communications unit, the method comprising:
determining if a location of the mobile communications unit in a selected area; and
in response to the mobile communications unit being in the selected area, sending a signal, wherein the signal causes at least one camera function in the mobile communications unit to be limited or disabled.

2. The method of claim 1, wherein the sending step comprises:
broadcasting the signal within the selected area.

3. The method of claim 1, wherein the sending step comprises:
transmitting the signal over a wireless transmission device.

4. The method of claim 1, wherein the mobile communications unit is one of a digital phone or a personal digital assistant.

5. The method of claim 1, wherein the at least one camera function is selected from one of operation of the camera to take a picture, selecting picture resolutions, an ability to record audio, an ability to record video, or a flash function in the camera.

6. The method of claim 1, wherein the selected area is one of a museum, theme park, concert hall, or a meeting room.

7. The method of claim 1, wherein the determining step includes:
identifying the location of the mobile communications unit using at least one of a global positioning system, a triangulation process, and a wireless transmission.

8. A method in a data processing system for managing a mobile communications unit having a camera, the method comprising:
monitoring for a presence of the mobile communications unit within a selected area; and
sending picture information for the camera to the mobile communications unit if the mobile communications unit is present in the selected area.

9. The method of claim 8, wherein the sending step comprises:
sending picture information that includes at least one of a location for taking a picture of interest and settings for taking the picture.

10. The method of claim 8, wherein the sending step comprises:
sending picture information that includes a command that disables the camera and an offer to download a picture to the mobile communications unit for a fee.

11. A mobile communications unit comprising:
a digital phone module; and
a camera module having a set of camera functions,
wherein at least one of the camera functions is disabled in response to receiving a selected signal.

12. The mobile communications unit of claim 11, wherein the set of camera functions includes at least one of operation of the camera to take a picture, resolutions of pictures taken by the camera, an ability to record audio, an ability to record video, and a flash function in the camera.

13. A computer program product in a computer readable medium for managing a camera in a mobile communications unit, the computer program product method comprising:
first instructions for determining if a location of the mobile communications unit is in a selected area; and
second instructions, responsive to the mobile communications unit being in the selected area, for sending a signal, wherein the signal causes at least one camera function in the mobile communications unit to be limited or disabled.

14. The computer program product of claim 13, wherein the second instructions causes the signal to be broadcast within the selected area.

15. The computer program product of claim 13, second instructions cause the signal to be sent over a wireless transmission device.

16. The computer program product of claim 13, wherein the mobile communications unit is one of a digital phone or a personal digital assistant.

17. The computer program product of claim 13, wherein the at least one camera function is selected from one of operation of the camera to take a picture, selecting picture resolutions, an ability to record audio, an ability to record video, or a flash function in the camera.

18. The computer program product of claim 13, wherein the selected area is one of a museum, theme park, concert hall, or a meeting room.

19. The computer program product of claim 13, wherein the first instructions identifies the location using at least one of a global positioning system, a triangulation process, and a wireless transmission.

20. A data processing system for managing a camera in a mobile communications unit, the data processing system comprising:
determining means for determining if a location of the mobile communications unit is in a selected area; and
sending means, responsive to the mobile communications unit being in the selected area, for sending a signal, wherein the signal causes at least one camera function in the mobile communications unit to be limited or disabled.
